(19) United States
(12) Patent Application Publication
(10) Pub. No.: US 2015/0293298 A1
(43) Pub. Date: Oct. 15, 2015

(54) LIGHTING DEVICE, DISPLAY DEVICE, AND TELEVISION DEVICE

(71) Applicant: Sharp Kabushiki Kaisha, Osaka-shi, Osaka (JP)

(72) Inventor: Eiji Hirota, Osaka-shi (JP)

(21) Appl. No.: 14/418,136

(22) PCT Filed: Aug. 23, 2013
(86) PCT No.: PCT/JP2013/072528

§ 371 Date: Jan. 29, 2015

(30) Foreign Application Priority Data
Aug. 31, 2012 (JP) 2012-191800

(51) Int. Cl. F21V 8/00; G02F 1/1335

(52) U.S. Cl. CPC G02B 6/0073; G02B 6/005; G02B 6/0016; G02B 6/0085; G02B 6/0068; G02F 1/133615

(57) ABSTRACT

A backlight device 12 includes LEDs 17, a light guide plate 16, an optical member 15, and heat dissipation members 30. The light guide member 16 includes light entrance surfaces 16b and a light exit surface 16a. The optical member 15 is arranged on the light exit surface 16a of the light guide plate 16. The heat dissipation members 30 are configured to dissipate heat from the LEDs 17. Each heat dissipation member 30 includes a light source mounting portion 31 to which the LEDs 17 are mounted, an extending portion 32, and protrusions 33. The extending portion 32 continues from the light source mounting portion 31 and extends from the light source mounting portion 31 along an opposite surface 16c of the light guide plate 16 from the light exit surface 16a. The protrusions 33 protrude from a surface 32a of the extending portion 32 on the light guide plate 16 side. The protrusions 33 are arranged in an extending direction of the extending portion 32 so as to be parallel to each other such that an area of the protrusions 33 per unit area decreases as a distance from the light source mounting portion 31 increases.

### TECHNICAL FIELD

The present invention relates to a lighting device, a display device, and a television device.

### BACKGROUND ART

Display components in image display devices, such as television devices, are now being shifted from conventional cathode-ray tube displays to thin display panels, such as liquid crystal panels and plasma display panels. With the thin display panels, the thicknesses of the image display devices can be reduced. A liquid crystal display device such as a liquid crystal television device requires a backlight device as a separately provided lighting device because a liquid crystal panel, which is a display panel, does not emit light itself. The backlight device in such a liquid crystal display device is generally classified into either a direct type or an edge-light type according to a mechanism thereof. It is considered that an edge-light type backlight device is more preferable for further reduction of the thickness of the liquid crystal display device. An example of such a display device is disclosed in Patent Document 1.

Patent Document 1 discloses a lighting device including a light source, a light guide member (a light guide plate), a heat dissipation member (a chassis), and a heat transfer member (a heat dissipation member). The light guide member includes a light entrance surface and a light exit surface that is perpendicular to the light entrance surface. The heat transfer member includes a light source holding portion (a light source mounting portion) and a plate-like portion (an extended portion) which is adjacent to the light source holding portion. The light source holding portion includes a surface that is opposed to the light entrance surface. The plate-like portion includes a surface that is opposed to the light exit surface and a surface that is opposed to the heat dissipation member.

### RELATED ART DOCUMENT

### Patent Document

Patent Document 1: Japanese Unexamined Patent Application Publication No. 2012-14949

### Problem to be Solved by the Invention

An optical sheet may be disposed inside the lighting device. Heat is more likely to be transferred from the heat dissipation member to an overlapping portion of the optical sheet which overlaps the extended portion in comparison to a non-overlapping portion thereof which does not overlap the extended portion. If a temperature gap at a border between the overlapping portion and the non-overlapping portion is large, a thermal expansion rate of the optical member may vary at the border. Namely, the thermal expansion rate of the overlapping portion may be significantly larger than the thermal expansion rate of the non-overlapping portion. Wrinkles or a deformation in the optical member may occur due to thermal expansion of the overlapping portion that overlaps the extending portion.

### DISCLOSURE OF THE PRESENT INVENTION

A present invention was made in view of the above circumstances. An object of the present invention is to reduce a temperature gap that occurs in the optical member to suppress wrinkles or a deformation in an optical member.

### Means for Solving the Problem

A lighting device according to the present invention includes a light source, a light guide plate, an optical sheet, and a heat dissipation member. The light guide plate is arranged opposite the light source. The light guide plate includes a light entrance surface through which light from the light source enters and a light exit surface through which the light exits. The optical sheet is arranged on the light exit surface of the light guide plate. The heat dissipation member is to dissipate heat from the light source. The heat dissipation member includes a light source mounting portion, an extending portion, and protrusions. The light source is mounted to the light source mounting portion. The extending portion is arranged on an opposite side of the light guide plate from the light exit surface. The extending portion continues from the light source mounting portion and extends from the light source mounting portion along an opposite surface of the light guide plate from the light exit surface. Protrusions protrude from a surface of the extending portion on the light guide plate side. The protrusions are arranged in an extending direction of the extending portion so as to be parallel to each other and such that an area of the protrusions per unit area decreases as a distance from the light source mounting portion increases.

In the lighting device, the area of the protrusions per unit area decreases as the distance from the light source mounting portion increases. Therefore, the amount of heat transferred from the heat dissipation member to the light guide plate via the protrusions decreases as the distance from the light source mounting portion increases. In comparison to the configuration that does not include the protrusions, the temperature gap in the optical sheet between the portion that does not overlap the extending portion and the portion that overlaps the extending portion is small. This configuration suppresses wrinkles or deformation of the optical sheet due to thermal expansion of the portion that overlaps the extending portion.

A lighting device according to the present invention includes a light source, a light guide plate, an optical sheet, and a heat dissipation member. The light guide plate is arranged opposite the light source. The light guide plate includes a light entrance surface through which light from the light source enters and a light exit surface through which the light exits. The optical sheet is arranged on the light exit surface of the light guide plate. The heat dissipation member is to dissipate heat from the light source. The heat dissipation member includes a light source mounting portion, an extending portion, and a low thermally conductive portion. The light source is mounted to the light source mounting portion. The extending portion is arranged on an opposite side of the light guide plate from the light exit surface. The extending portion continues from the light source mounting portion along an opposite surface of the light guide plate from the light exit surface such that a thickness of the extending portion increases as a distance from the light source mounting portion increases. The low thermally conductive portion is on a surface of the extending portion. The low thermally conductive portion has thermal conductivity lower than the extending portion. The low thermally conductive portion has a thickness that decreases as a distance from the light source mounting portion increases.

In the lighting device, the thickness of the extending portion decreases as the distance from the light source mounting portion increases and the thickness of the low thermally conductive portion increases as the distance from the light source mounting portion increases. Therefore, the amount of heat transferred from the heat dissipation member to the light guide plate via the extending portion and the low thermally conductive portion decreases as the distance from the light source mounting portion increases. In comparison to the configuration that does not include such an extending portion or a low thermally conductive portion, the temperature gap in the optical sheet between the portion that does not overlap the extending portion and the portion that overlaps the extending portion is small. This configuration suppresses wrinkles or deformation of the optical sheet due to thermal expansion of the portion that overlaps the extending portion.

Preferable embodiments may include the following configurations.

(1) Each of the protrusions may have a dimension that measures in the extending direction of the extending portion. The dimension may decrease as the distance from the light source mounting portion increases. This configuration is preferable for implementing the configuration in which the area of the protrusions per unit area decreases as the distance from the light source mounting portion increases.

(2) The protrusions may be arranged such that an interval between the protrusions increases as the distance from the light source mounting portion increases. This configuration is preferable for implementing the configuration in which the area of the protrusions per unit area decreases as the distance from the light source mounting portion increases.

(3) Each of the protrusions may extend from one end to another in a direction perpendicular to the extending direction of the extending portion. With this configuration, the heat is uniformly transferred from the heat dissipation member to the light guide plate in the direction perpendicular to the extending direction of the extending portion.

(4) The heat dissipation member may be formed such that the light source mounting portion and the extending portion form an L-like cross section. The protrusions are integrally formed with the extending portion. The protrusions extend along a corner defined by the light source mounting portion and the extending portion. According to this configuration, the protrusions are formed at the same time when the light source mounting portion and the extending portion are formed in the extrusion process of the heat dissipation member. Namely, the heat dissipation member can be easily formed.

(5) The protrusions may be made of material having lower thermal conductivity than the extending portion. With this configuration, the amount of heat transferred from the heat dissipation member to the light guide plate via the protrusions further decreases.

(6) The extending portion may include a surface on a light guide plate side configured as a sloped surface that is sloped such that a distance from the opposite surface of the light guide plate from the light exit surface increases as a distance from the light source mounting portion increases. According to this configuration, the amount of heat transferred from the light source mounting portions to the light guide plate via the extending portion gradually decreases as the distances from the light source mounting portions increase.

(7) The extending portion and the low thermally conductive portion may be attached to each other in a flat plate-like form. Because the extending portion and the low thermally conductive portion are in the flat plate-like form, the extending portion and the low thermally conductive portion that are attached to each other can be arranged parallel to the light guide plate. Therefore, the heat dissipation member and the light guide plate are stably fixed together.

(8) The lighting device may further include a chassis arranged on an opposite side from the light exit surface of the light guide plate relative to the light guide plate and the extending portion. The chassis may include a bottom plate portion and a holding portion. An opposite surface of the light guide plate from the light exit surface may be plated on the bottom plate portion. The holding portion may form a step together with the bottom plate. The holding portion may hold the extending portion while being in contact with a surface of the extending portion on a side opposite from the light guide plate. With this configuration, the light guide plate is stably supported by the bottom-plate portion and the heat from the light source is dissipated via the entire area of the chassis by transferring the heat from the extending portion to the holding portion. Namely, this configuration has high heat dissipation capability.

(9) The lighting device may further include a light source board on which light sources each having the same configuration as that of the light source are mounted. The light sources are mounted to the light source mounting portion via the light source board. According to this configuration, the light sources are easily mounted to the heat dissipation member and the heat from the light sources is efficiently transferred to the light source mounting portion.

To solve the problem described earlier, a display device according to the present invention includes the above described lighting device and a display panel configured to display images using light from the light exit surface of the light guide plate included in the lighting device. According to this display device, because the backlight device includes the optical member configured to have less wrinkles and deformation, high display quality of the liquid crystal display device is achieved.

Examples of the display panel include the liquid crystal panel. Such a display device, that is, the liquid crystal display device can be applied to various devices including television devices and displays for personal computers. The liquid crystal display device is especially suitable for large screen applications.

### Advantageous Effect of the Invention

According to the present invention, a lighting display device in which wrinkles or a deformation in an optical member is suppressed is provided.

### BRIEF DESCRIPTION OF THE DRAWINGS

FIG. 1 is an exploded perspective view of a television device TV and a liquid crystal display unit LDU illustrating a schematic configuration thereof according to a first embodiment.

FIG. 2 is a rear view of the television device TV and the liquid crystal display device 10.

FIG. 3 is an exploded perspective view of the liquid crystal display device 10 illustrating a schematic configuration of the liquid crystal display unit LDU included therein.

FIG. 4 is a cross-sectional view of the liquid crystal display device 10 along a short-side direction thereof illustrating a cross-sectional configuration.

FIG. 5 is a cross-sectional view of the liquid crystal display device 10 along a long-side direction thereof illustrating a cross-sectional configuration.

FIG. 6 is a magnified cross-sectional view of a relevant portion of a backlight device 12 in FIG. 4 including an LED unit LU and a portion therearound.

FIG. 7 is a plan view of the LED unit LU.

FIG. 8 is a graph illustrating a relationship between temperature of an optical sheet and distance from a light source mounting portion.

FIG. 9 is a magnified cross-sectional view of a relevant portion of a backlight device 12-1 including an LED unit LU and a portion therearound illustrating a cross-sectional configuration along a short-side direction of a liquid crystal display device 10-1 according to a first modification of the first embodiment.

FIG. 10 is a magnified cross-sectional view of a relevant portion of a backlight device 12-2 including an LED unit LU and a portion therearound illustrating a cross-sectional configuration along a short-side direction of a liquid crystal display device 10-2 according to a second modification of the first embodiment.

FIG. 11 is a magnified cross-sectional view of a relevant portion of a backlight device 112 including an LED unit LU and a portion therearound illustrating a cross-sectional configuration along a short-side direction of a liquid crystal display device 110 according to a second embodiment.

FIG. 12 is a magnified cross-sectional view of a relevant portion of a backlight device 212 including an LED unit LU and a portion therearound illustrating a cross-sectional configuration along a short-side direction of a liquid crystal display device 210 according to a third embodiment.

### MODE FOR CARRYING OUT THE INVENTION

### First Embodiment

A first embodiment will be described with reference to the drawings. A liquid crystal display device 10 (an example of a display device) will be described. The drawings may include X-axis, Y-axis and Z-axis. The axes in each drawing correspond to the respective axes in other drawings. The Y-axis direction corresponds to a vertical direction and the X-axis direction corresponds to a horizontal direction. An upper side and a lower side are defined based on the vertical direction unless otherwise specified.

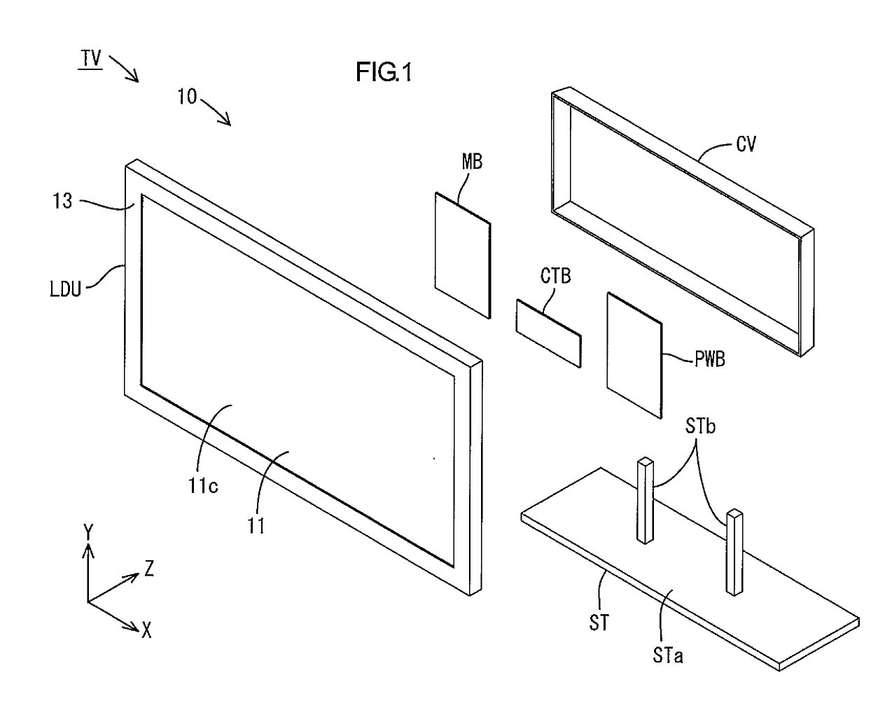

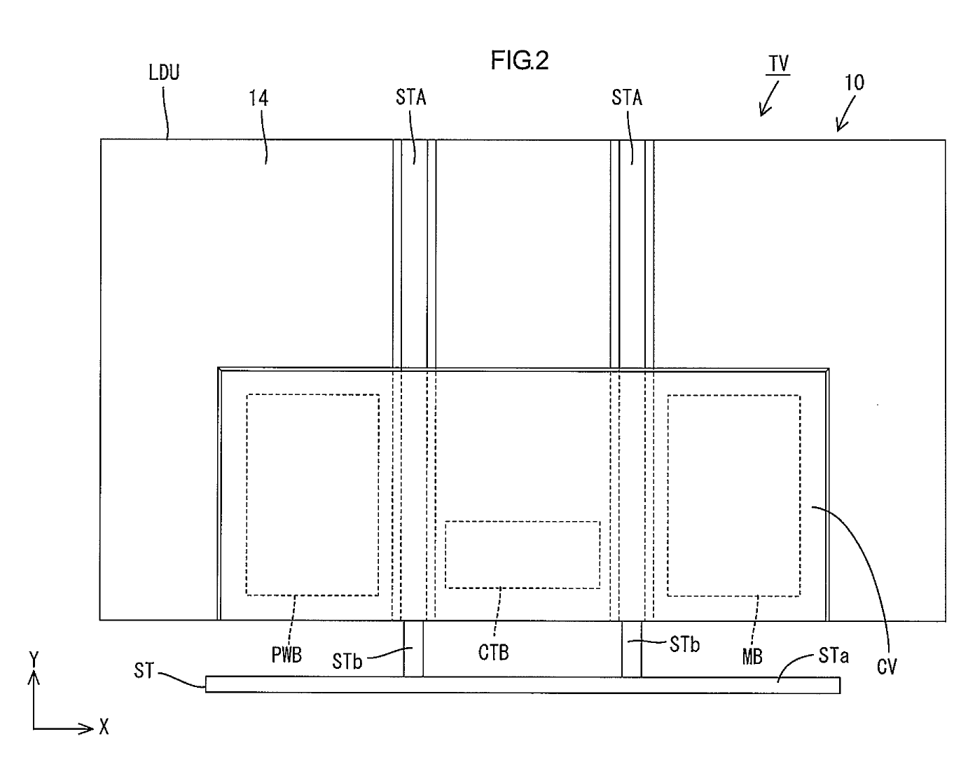

As illustrated in FIG. 1, a television device TV includes a liquid crystal display unit LDU, boards PWB, MB, and CTB, a cover CV, and a stand ST. The boards PWB, MB, and CTB are attached to a rear surface (a back surface) of the liquid crystal display unit LDU. The cover CV is attached to the rear surface of the liquid crystal display unit LDU so as to cover the boards PWB, MB, and CTB. The stand ST holds the liquid crystal display unit LDU such that a display surface of the liquid crystal display unit LDU extends in the vertical direction (the Y-axis direction). The liquid crystal display device 10 according to this embodiment has the same configuration as the above-described television device TV except for at least a component for receiving television signals (e.g. a tuner included in a main board MB). As illustrated in FIG. 2, the liquid crystal display unit LDU has a horizontally-long rectangular overall shape (rectangular and longitudinal). The liquid crystal display unit LDU includes a liquid crystal panel 11 as a display panel and a backlight device 12 as a light source. The liquid crystal panel 11 and the backlight device 12 are collectively held by a frame 13 and a chassis 14. The frame 13 and the chassis 14 are external members that form an external appearance of the liquid crystal display device 10. The chassis 14 in this embodiment is one of the external members and a portion of the backlight device 12.

A configuration of the liquid crystal display device 10 on a rear surface side will be described. As illustrated in FIG. 2, stand fitting members STA are attached to a rear surface of the chassis 14 that forms the rear external appearance of the liquid crystal display device 10. The stand fitting members STA are spaced away from each other in an X-axis direction and extend along the Y-axis direction. Each stand fitting member STA has a channel beam-like cross section that opens to the chassis 14. A space is provided between the stand fitting member STA and the chassis 14. Support portions STb included in the stand ST are inserted in the respective stand fitting members STA. The space provided in the stand fitting member STA is configured to be a path through which wiring members (e.g. electric wires) which are connected to an LED board 18 are passed. The LED board 18 is included in the backlight device 12. The stand ST includes abase STa and the support portions STb. The base STa extends parallel to the X-Z plane. The support portions STb stand on the base STa in the Y-axis direction. The cover CV is made of synthetic resin and attached to a part of the rear surface of the chassis 14. Specifically, as illustrated in FIG. 2, the cover CV covers a lower half part of the chassis 14 so as to cross over the stand fitting members STA in the X-axis direction. A component storage space is provided between the cover CV and the chassis 14 such that the boards PWB, MB, and CTB, which will be described next, are arranged therein.

As illustrated in FIG. 2, the boards PWB, MB, and CTB are a power source board PWB, a main board MB, and a control board CTB. The power source board PWB is a power supply of the liquid crystal display device 10, which is configured to supply drive power to the other boards MB and CTB and LEDs 17 included in the backlight device 12. Namely, the power source board PWB is configured as “an LED drive board that drives the LEDs 17”. The main board MB includes at least a tuner and an image processor (both of them are not illustrated). The tuner is configured to receive television signals. The image processor performs image processing on the received television signals. The main board MB is configured to output the processed image signals to the control board CTB. If an external image reproducing device, which is not illustrated, is connected to the liquid crystal display device 10, image signals from the image reproducing device are input to the main board MB. The image processor included in the main board MB processes the image signals, and the main board MB outputs the processed image signals to the control board CTB. The control board CTB is configured to convert the image signals, which is sent from the main board, to driving signals for liquid crystals and to supply the driving signals to the liquid crystal panel 11.

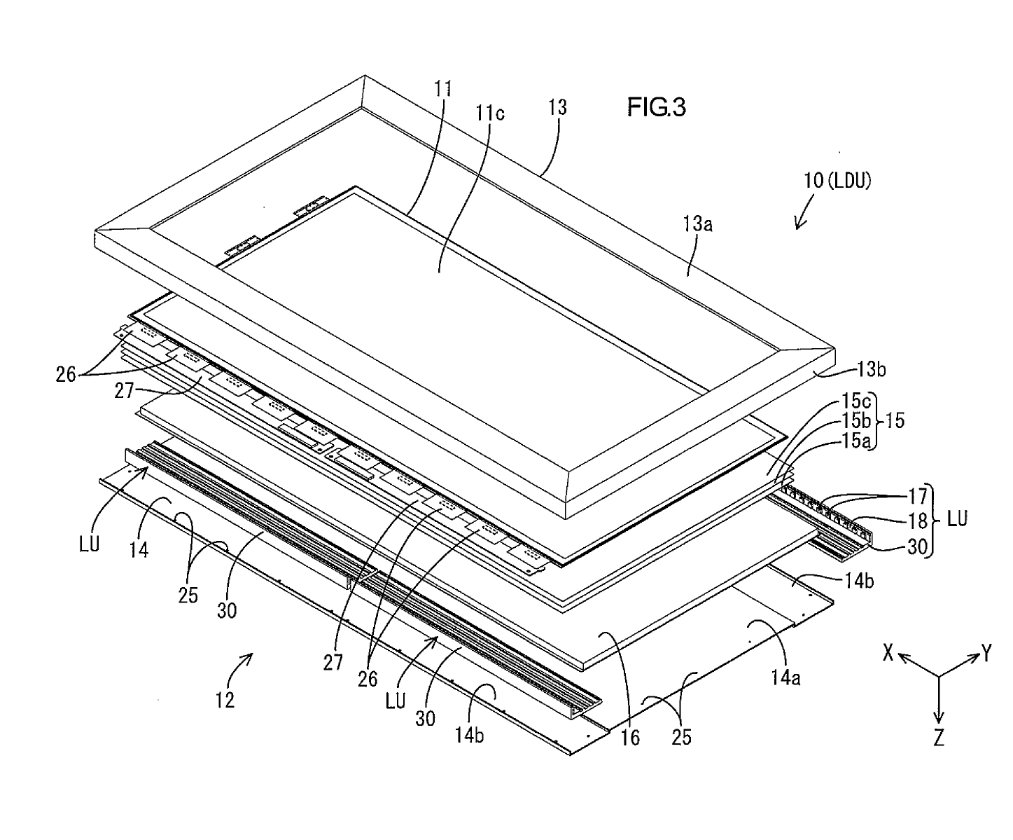

As illustrated in FIG. 3, components of the liquid crystal display unit LDU included in the liquid crystal display device 10 are arranged in a space provided between the frame 13 that forms the front external appearance and the chassis 14 that form the rear external appearance. The components arranged between the frame 13 and the chassis 14 include at least the liquid crystal panel 11, an optical member 15, a light guide plate 16, and LED units LU. The liquid crystal panel 11, the optical member 15, and the light guide plate 16 are placed on top of one another and held between the frame 13 on the front side and the chassis 14 on the rear side. The backlight device 12 includes the optical member 15, the light guide plate 16, the LED units LU, and the chassis 14. Namely, the backlight device 12 corresponds to the liquid crystal display unit LDU without the liquid crystal panel 11 and the frame 13. Two LED units LU included in the backlight device 12 are arranged so as to sandwich the light guide plate 16 in the short-side direction of the light guide plate 16 (in the Y-axis direction). Each LED unit LU includes the LEDs 17 as light sources, the LED board 18, and a heat dissipation member (a heat spreader) 19. The LEDs 17 are mounted on the LED board 18. The LED board 18 is attached to the heat dissipation member 19. Each component will be described next.

As illustrated in FIG. 3, the liquid crystal panel 11 has a horizontally-long rectangular shape (rectangular and longitudinal) in a plan view and includes a pair of glass substrates 11a and 11b and liquid crystals. The substrates 11a and 11b having high light transmissivity are bonded together with a predetermined gap therebetween. The liquid crystals are sealed between the substrates 11a and 11b. On one of the substrates (an array board 11b), switching elements (e.g. TFTs), pixel electrodes, and an alignment film are arranged. The switching elements are connected to gate lines and source lines that are arranged perpendicular to each other. The pixel electrodes are connected to the switching elements. On the other one of the substrates (a CF board 11a), color filters, a counter electrode, and an alignment film are arranged. The color filters include red (R), green (G), and blue (B) color portions that are arranged in a predetermined arrangement. The liquid crystal panel 11 is placed on a front side of the optical member 15, which will be described later. A rear-side surface of the liquid crystal panel 11 (an outer-side surface of a polarizing plate on the rear side) is fitted to the optical member 15 with minimal gaps therebetween. Therefore, dust is less likely to enter between the liquid crystal panel 11 and the optical member 15. The liquid crustal panel 11 includes a display surface 11c. The display surface 11c includes a display area and a non-display area. The display area is an inner area of a screen in which images are displayed. The non-display area is an outer area of the screen around the display area with a frame-like shape. The liquid crystal panel 11 is connected to the control board CTB via a driver for driving the liquid crystals and flexible boards 26. The liquid crustal panel 11 displays images in the display area of the display surface 11c based on signals sent from the control board CTB. The polarizing plates (not illustrated) are arranged on outer sides of the substrates 11a and 11b.

As illustrated in FIG. 3, similar to the liquid crystal panel 11, the optical member 15 has a horizontally-long rectangular shape in a plan view and has a size (i.e., a short-side dimension and a long-side dimension) about equal to the liquid crystal panel 11. The optical member 15 is placed on the front side of the light guide plate 16 (a light exit side), which will be described later, and sandwiched between the light guide plate 16 and the liquid crystal panel 11. The optical member 15 includes three sheets that are placed on top of one another. Specifically, a diffuser sheet 15a, a lens sheet (a prism sheet) 15b, and a reflecting type polarizing sheet 15c are placed on top of one another in this sequence from the rear side (the light guide plate side). The three sheets 15a, 15b, and 15c have the substantially same size in a plan view.

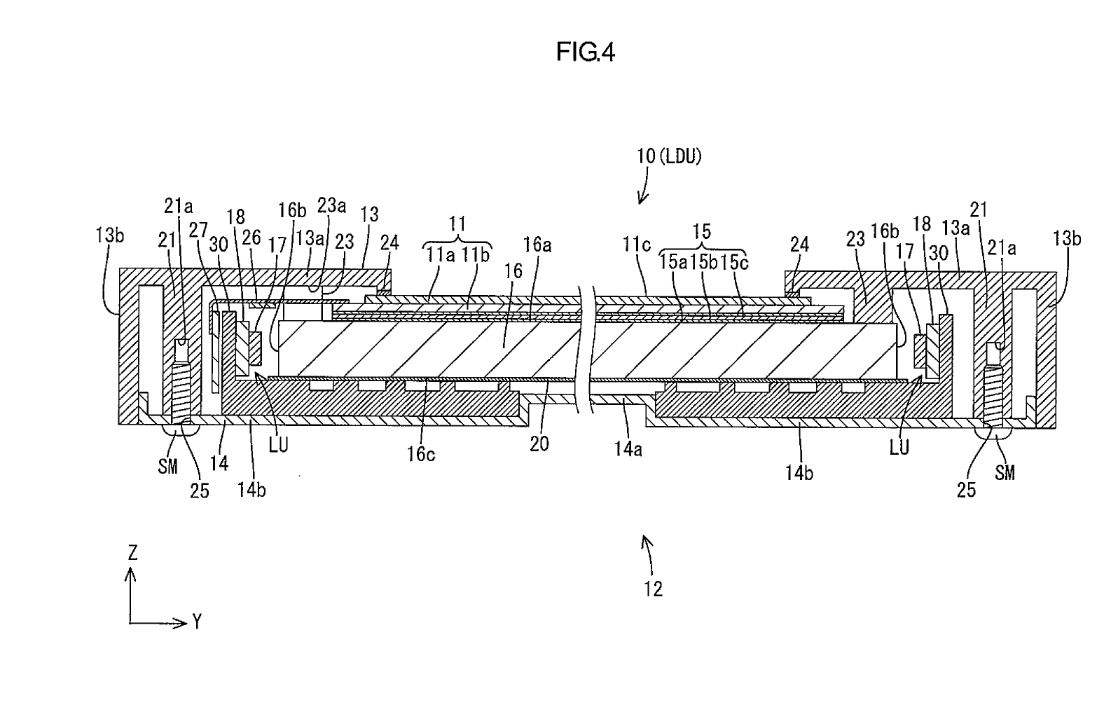

The light guide plate 16 is made of substantially transparent (high transmissivity) synthetic resin (e.g. acrylic resin or polycarbonate such as PMMA) which has a refractive index sufficiently higher than that of the air. As illustrated in FIG. 3, the light guide plate 16 has a horizontally-long rectangular shape in a plan view similar to the liquid crystal panel 11 and the optical member 15. A thickness of the light guide plate 16 is larger than a thickness of the optical member 15. A long-side direction and a short-side direction of a main surface of the light guide plate 16 correspond to the X-axis direction and the Y-axis direction, respectively. A thickness direction of the light guide plate 16 that is perpendicular to the main surface of the light guide plate 16 corresponds to the Z-axis direction. The light guide plate 16 is arranged on the rear side of the optical member 15 and sandwiched between the optical member 15 and the chassis 14. As illustrated in FIG. 4, at least a short-side dimension of the light guide plate 16 is larger than those of the liquid crystal panel 11 and the optical member 15. The light guide plate 16 is arranged such that ends of the short dimension thereof (i.e., ends along a long-side direction of the light guide plate 16) protrude over ends of the liquid crystal panel 11 and the optical member 15 (so as not to overlap in a plan view). The LED units LU are arranged on sides of the short dimension of the light guide plate 16 so as to have the light guide plate 16 between the LED units LU in the Y-axis direction. Rays of light from the LEDs 17 enter the light guide plate 16 through the ends of the short dimension of the light guide plate 16. The light guide plate 16 is configured to transmit the light, which is from the LEDs 17 and enters the light guide plate 16 through the ends of the short dimension, therethrough and guide toward the optical member 15 (to the front side).

One of the main surfaces of the light guide plate 16 facing the front side (a surface opposite the optical member 15) is a light exit surface 16a. Light exits the light guide plate 16 through the light exit surface 16a toward the optical member 15 and the liquid crystal panel 11. The light guide plate 16 includes outer peripheral surfaces that are adjacent to the main surfaces of the light guide plate 16, and long edge surfaces (at ends of the short dimension) which have elongated shapes along the X-axis direction are opposite the LEDs 17 (the LED boards 18). A predetermined space is provided between each long-side end and the LEDs 17 (the LED boards 18). The long edge surfaces are light entrance surfaces 16b through each of which light from LEDs 17 enters. The light entrance surfaces 16b are parallel to each other along the X-Z plane (or the main surfaces of the LED boards 18) and substantially perpendicular to the light exit surface 16a. An arrangement direction of the LEDs 17 and the light entrance surface 16b corresponds to the Y-axis direction and parallel to the light exit surface 16a.

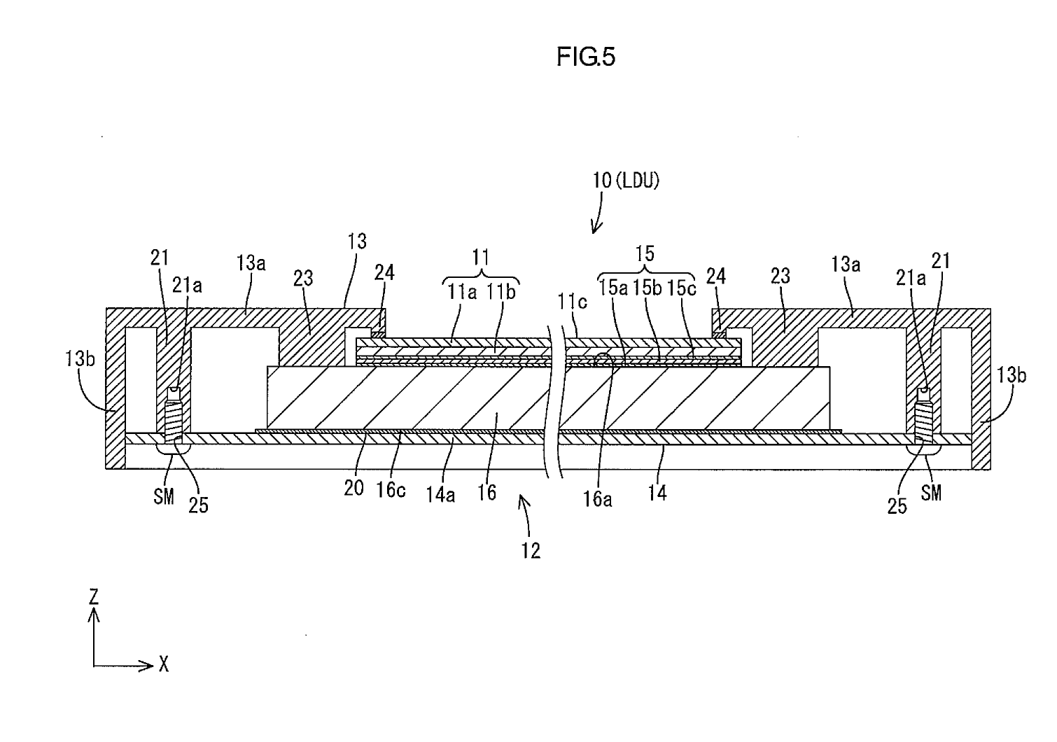

As illustrated in FIGS. 4 and 5, a reflection sheet 20 is arranged on the rear side of the light guide plate 16, i.e., on an opposite surface 16c that is opposite from the light exit surface 16a (a surface opposite the chassis 14). The reflection sheet 20 is configured to reflect the light that exits from the opposite surface 16c to the rear side toward the front side. The reflection sheet 20 is arranged to cover an entire area of the opposite surface 16c. The reflection sheet 20 is arranged so as to be sandwiched between the chassis 14 and the light guide plate 16. The reflection sheet 20 is made of synthetic resin and has a white surface having high light reflectivity. A short-side dimension of the reflection sheet 20 is larger than that of the light guide plate 16. The reflection sheet 20 is arranged such that ends of the short dimension thereof protrude closer to the LEDs 17 compared to the light entrance surfaces 16b of the light guide plate 16. Light that travels at an angle from the LEDs 17 toward the chassis 14 is effectively reflected toward the light entrance surfaces 16b of the light guide plate 16 by the protruded portions of the reflection sheet 20. At least one of the light exit surface 16a and the opposite surface 16c of the light guide plate 16 includes a reflecting portion (not illustrated) or a scattering portion (not illustrated). The reflecting portion reflects light inside the light guide plate 16. The scattering portion scatters light inside the light guide plate 16. Each of the reflecting portion and the scattering portion is patterned so as to have predetermined in-plane distribution so that the light that exits from the light exit surface 16a is controlled to have uniform distribution within the surface.

Next, configurations of each of the LEDs 17, the LED board 18, and the heat dissipation member 30 included in each LED unit LU will be described. As illustrated in FIGS. 3 and 4, the LED 17 included in the LED unit LU has a configuration in which each LED chip fixed on the LED board 18 is sealed with resin. The LED chip mounted on the board has one main light emission wavelength. Specifically, the LED chip that emits light in a single color of blue is used. The resin that seals the LED chip contains phosphors dispersed therein. The phosphors emit light in a predetermined color when excited by blue light emitted from the LED chip. Thus, overall color of light emitted from the LED 17 is white. The phosphors may be selected, as appropriate, from yellow phosphors that emit yellow light, green phosphors that emit green light, and red phosphors that emit red light. The phosphors may be used in combination of the above phosphors. The LED 17 includes a main light-emitting surface that is opposite from a mounting surface mounted to the LED board 18 (an opposed surface opposite the light entrance surfaces 16b of the light guide plate 16). Namely, the LED 17 is a so-called top-surface-emitting type LED.

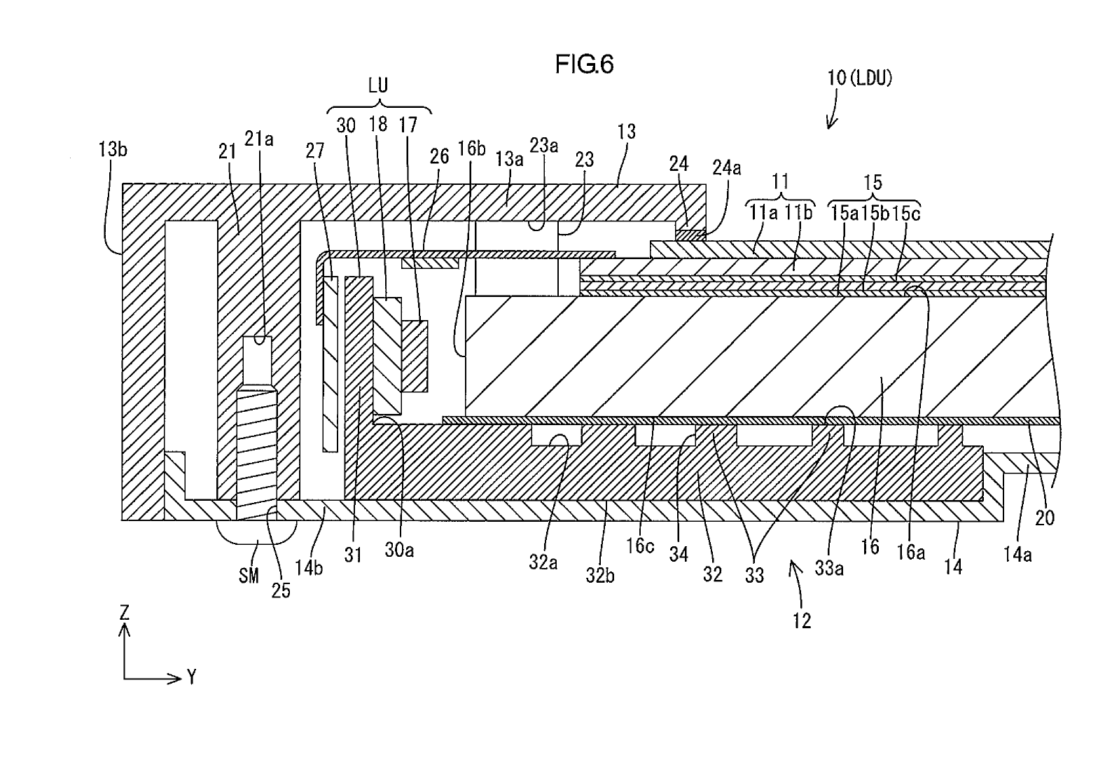

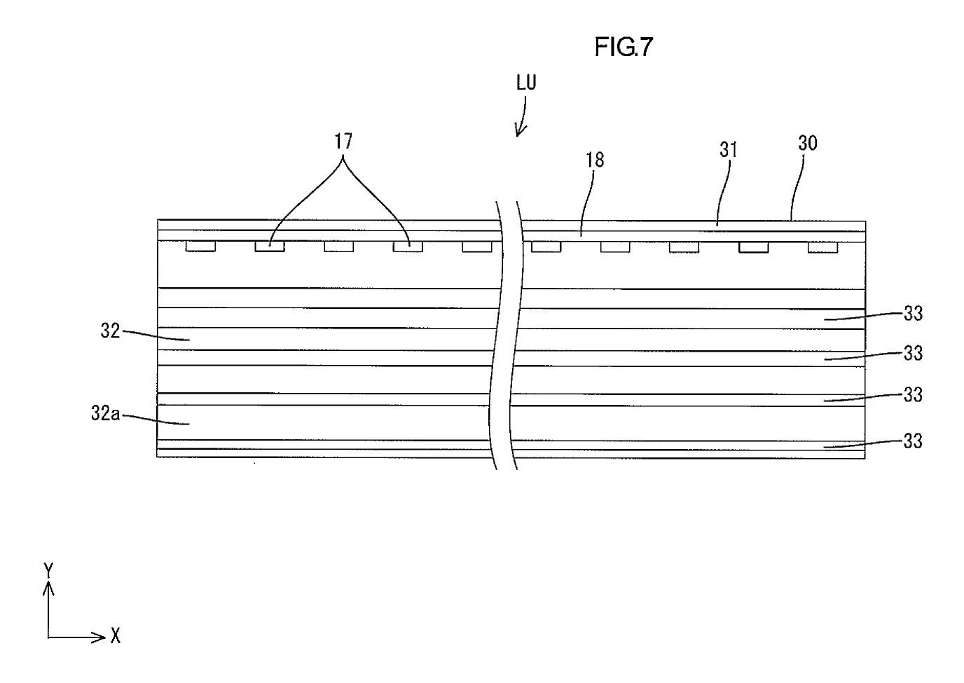

The heat dissipation member 30 included in each LED unit LU is made of metal having high thermal conductivity, such as aluminum. The heat dissipation member 30 is configured to dissipate heat from the LEDs 17. As illustrated in FIGS. 6 and 7, the heat dissipation member 30 includes a light source mounting portion 31, an extending portion 32, and protrusions 33. The LEDs 17 are mounted on the light source mounting portion 31. The extending portion 32 continues from the light source mounting portion 31 and extends from the light source mounting portion 31 along the opposite surface 16c of the light guide plate 16 opposite from the light exit surface 16a. The protrusions 33 protrude from a surface 32a of the extending portion 32 on the light guide plate 16 side. The protrusions 33 are arranged in an extending direction in which the extending portion 32 extends. The heat dissipation member 30 bends such that the light source mounting portion 31 and the extending portion 32 form an L-like shape in a cross section. The heat dissipation member 30 may be formed by extrusion with the X-axis direction as an extruding direction. Portions of the heat dissipation member 30 will be described in detail later.

Next, configurations of the frame 13 and the chassis 14 that are members to form the exterior appearance and holding members will be described. The frame 13 and the chassis 14 are made of metal such as aluminum. In comparison to synthetic resin, the mechanical strength (rigidity) and thermal conductivity are higher. The frame 13 and the chassis 14 hold the liquid crystal panel 11, the optical member 15, and the light guide plate 16, which are placed on top of the other, from the front side and the rear side, respectively, while holding the LED units LU corresponding to each other at ends of the short dimension (i.e., on the long edges) therein.

As illustrated in FIG. 3, the frame 13 has a horizontally-long rectangular frame-like overall shape that surrounds the display area of the display surface 11c of the liquid crystal panel 11. The frame 13 includes a panel holding portion 13a and the sidewall portion 13b. The panel holding portion 13a is parallel to the display surface 11c of the liquid crystal panel 11 and holds the liquid crystal panel 11 from the front side. The sidewall portion 13b continues from the panel holding portion 13a and extends on the light entrance surface 12b side of the light guide plate 16 toward the rear side. The panel holding portion 13a and the sidewall portion 13b form an L-like shape in a cross section. The panel holding portion 13a has a horizontally-long rectangular frame-like shape that corresponds to an outer edge portion of the liquid crystal panel 11 (i.e., the non-display area, a frame-like portion). The panel holding portion 13a holds a substantially entire area of the outer portion of the liquid crystal panel 11 from the front side. The long edges of the light guide plate 16 are located outer in the radial direction than the long edges of the liquid crystal panel 11. The panel holding portion 13a has a width that is sufficient to cover not only the outer edge portion of the liquid crystal panel 11 but also the long edges of the light guide plate 16 and LED units 30 from the front side. Similar to the display surface 11c of the liquid crystal panel 11, a front exterior surface of the panel holding portion 13a (an opposed surface from the surface facing the liquid crystal panel 11) is viewable from the front side of the liquid crystal display device 10. The panel holding portion 13a and the display surface 11c of the liquid crystal panel 11 form a front exterior of the liquid crystal display device 10. The sidewall portion 13b has a rectangular column-like shape that projects from an outer peripheral portion (specifically, an outer peripheral end portion) of the panel holding portion 13a to the rear side. The sidewall portion 13b is configured to surround the liquid crystal panel 11, the optical member 15, the light guide plate 16, and the LED units LU held therein for an entire periphery. Furthermore, the sidewall portion 13b is configured to surround the chassis 14 on the rear side for the entire periphery. An outer surface of the sidewall portion 13b along the periphery of the liquid crystal display device 10 is viewable, that is, located at the outer periphery of the liquid crystal display device 10. The outer surface forms a top surface, a bottom surface, and side surfaces of the liquid crystal display device 10.

The panel holding portion 13a includes screw mounting portions 21. Each of the screw mounting portions 21 is located closer to an interior side than the peripheral wall 13b of the panel holding portion 13a (a position close to the light guide plate 16). Screw members SM are attached to the screw mounting portions 21. The screw mounting portion 21 protrudes from an inner surface of the panel holding portion 13a in the Z-axis direction toward the rear side and has an elongated block-like shape that extends along each side of the panel holding portion 13a (in the X-axis direction or the Y-axis direction). As illustrated in FIGS. 4 and 5, the screw mounting portion 21 includes a groove 21a that opens to the rear side and for fastening the screw member SM. The chassis 14 includes insertion holes 25 that are aligned with the groove 31a and through which the screws SM are passed.

As illustrated in FIGS. 4 and 5, a panel holding projection 24 is integrally formed with the panel holding portion 13a at the inner edge portions of the panel holding portion 13a. The panel holding projection 24 projects toward the rear side, that is, toward the liquid crystal panel 11. A cushioning member 24a is attached to distal end surfaces of the panel holding projections 24. The panel holding projection 24 holds the liquid crystal panel 11 from the front side via the cushioning member 24a. Each of the panel holding projection 24 and the cushioning member 24a has a frame-like overall shape. The panel holding projection 24 and the cushioning member 24a are arranged along the inner peripheral edge of the panel holding portion 13a for the entire periphery. As illustrated in FIGS. 4 and 5, light guide plate holding projections 23 are integrally formed with the panel holding portion 13a between the panel holding projection 24 and the screw mounting portion 21. The light guide plate holding projections 23 project on the rear side, that is, toward the light guide plate 16. The light guide plate holding projections 23 press long edge portions of the light guide plate 16 (peripheral edge portions) from the front side toward the chassis 14. The light guide plate holding projection 23 of one of long-side portions of the frame 13 includes cutout 23a formed in a portion so as to run through the frame 13 in the short-side direction of the frame 13 (the Y-axis direction). A source-side flexible circuit board 261 connected to an end of the liquid crystal panel 11 is passed through the cutout 23a.

As illustrated in FIG. 3, the chassis 14 has a horizontally-long shallow tray-like overall shape and covers substantially entire areas of the light guide plate 16 and the LED units LU from the rear side. A rear outer surface of the chassis 14 (a surface of the chassis 14 opposite from a surface that faces the light guide plate 16 and the LED units LU) is viewed from the rear side and forms a back exterior of the liquid crystal display device 10. The chassis 14 includes a bottom-plate portion 14a and a pair of holding portions 14b. The bottom-plate portion 14a has a horizontally-long rectangular shape similar to the light guide plate 16. The holding portions 14b protrude from long edges of the bottom-plate portion 14a toward the rear side in a step-like form. The holding portions 14b hold the extending portions 32 of the respective heat dissipation members 30. As illustrated in FIG. 4, the bottom-plate portion 14a has a flat plate-like shape to hold the most of the middle portion of the short-edge portions of the light guide plate 16 (portions of the short-edge portions except for end portions) from the rear side. Namely, the bottom-plate portion 14a is a receiving portion for the light guide plate 16.

As illustrated in FIG. 4, the holding portions 14b are arranged so as to sandwich the bottom-plate portion 14a from sides with respect to the short-edge direction. Each of the holding portions 14b is formed recessed toward the rear than the bottom plate 14a for holding the extending portion 32 of the corresponding heat dissipation member 30 therein. Each holding portion 14b includes a raised portion that projects from the bottom-plate portion toward the rear and a holding bottom-plate portion that is parallel to the bottom-plate portion 14a. The extending portion 32 of the heat dissipation member 30 included in the LED unit LU is disposed on a plate surface of the holding bottom plate portion of the holding portion 14b such that the extending portion 32 and the plate surface are in surface contact.

Next, each of the heat dissipation members 30, which is one of main components of this embodiment, will be described. As illustrated in FIG. 6, the light source mounting portion 31 of the heat dissipation member 30 has a plate-like shape parallel to a plate surface of the LED board 18 and the light entrance surface 16b of the light guide plate 16 with a long-side direction, a short-side direction, and a thickness direction aligned with the X-axis direction, the Z-axis direction, and the Y-axis direction, respectively. The LEDs 17 are mounted to an inner plate surface of the light source mounting portion 31, that is, a plate surface opposite the light guide plate 16 via the LED board 18. The light source mounting portion 31 has a long dimension about equal to the long dimension of the LED board 18 and the short dimension larger than the short dimension of the LED board 18. Ends of the short dimension of the light source mounting portion 31 project outward over the respective ends of the LED board 18 in the Z-axis direction. An outer surface of the light source mounting portion 31, that is, a surface opposite from the surface on which the LED board 18 is mounted is opposite the screw mounting portion 21 of the frame 18. Namely, the light source mounting portion 31 is arranged between the screw mounting portion 21 of the frame 13 and the light guide plate 16.

As illustrated in FIG. 7, the extending portion 32 has a rectangular shape in a plan view. The extending portion 32 has a plate-like shape parallel to the plate surfaces of the light guide plate 16 and the chassis 14 with a long-side direction, a short-side direction, and a thickness direction thereof aligned with the X-axis direction, the Z-axis direction, and the Y-axis direction, respectively. As illustrated in FIG. 6, the extending portion 32 extends inward from an end of the light source mounting portion 31 on the rear side, that is, an end closer to the chassis 14, that is, extends on the light guide plate 16 side along the Y-axis direction. A distal end of the extending portion 32 is located behind the light guide plate 16 and the reflection sheet 20. Namely, the extending portion 32 is sandwiched between the reflection sheet 20 and the chassis 14. A length of the extending portion 32 that measures in a direction in which the extending portion 32 extends is defined based on heat dissipation capability of the heat dissipation member 30. The extending portion 32 extends in an area that overlaps the optical member 14 in a plan view. A rear plate surface of the extending portion 32, that is, a surface 32b opposite the chassis 14 is in surface contact with the plate surface of the chassis 14 (a holding bottom surface) for an entire area thereof. Protrusions 33 are formed on a front plate surface of the extending portion 32, that is, a surface 32a opposite the light guide plate (or the reflection sheet 20).

As illustrated in FIG. 6, the protrusions 33 protrude from the surface 32a of the extending portion 32 on the rear side in a form of ribs. The protrusions 33 are integrally formed with the extending portion 32. The protrusions 33 extend along a corner 30a defined by the light source mounting portion 31 and the extending portion 32 that form an L-like cross section. As illustrated in FIG. 7, each of the protrusions 33 has a rectangular column-like shape that extends from one edge to the other in a direction perpendicular to the extending direction of the extending portion 32 (the X-axis direction). As illustrated in FIG. 6, the surface 32a of the protrusion 33 on the light guide plate 16 side is in surface contact with the reflection sheet 20. Heat is transferred from the surface 33a on the light guide plate 16 side to the light guide plate 16 via the reflection sheet 20. Groove-like recesses 34 are formed between the adjacent protrusions 33, 33, respectively. Each of the recesses 34 is defined by opposed side surfaces of the adjacent protrusions 33, 33 and the surfaces 32a of the extending portion 32 on the light guide plate 16 side. An inside of each recess 34 is an air space. The thermal conductivity of the heat dissipation member 30 is lower in the recess 34 than at the protrusion 33.

As illustrated in FIG. 6, the protrusions 33 are arranged parallel to each other in the extending direction of the extending portion 32 (the Y-axis direction). Namely, in a plan view of the extending portion 32, the protrusions 33 and the surfaces 32a of the extending portion 32 on the light guide plate side (in the recesses 34) are arranged in a strip pattern. The protrusions 33 are configured such that an area of the protrusions per unit area decreases as a distance from the light source mounting portion 31 increases. The area of the protrusions 33 per unit area is a sum of the areas of the protrusions 33 that are formed within a predetermined region when the heat dissipation member 30 and the extending portion 32 are viewed in plan. Namely, a percentage of a dimension of the protrusions relative to a dimension of the recesses 34 per unit length in the extending direction of the extending portion 32 decreases as a distance from the light source mounting portion 31 increases. The protrusions 33 are configured such that the dimensions in the extending direction of the extending portion 33 (the Y-axis direction) decrease as the distance from the light source mounting portion 31 increases. The protrusions 33 are further configured such that an interval therebetween in the extending direction increases as the distance from the light source mounting portion 31 increases. Dimensions of the protrusions 33 in a direction in which they protrude (dimensions that measure in the Z-axis direction) are equal. The surfaces 33a on the light guide plate 16 side are on the same plane. According to such a configuration, the light guide plate 16 is stably supported by the protrusions 33.

Next, functions of this embodiment will be described. When the liquid crystal display device 10 is turned on, power is supplied from the power source board PWB to the control board CTB and signal are transmitted to the liquid crystal panel 11 via the printed circuit board 27 and the flexible circuit boards 26. As a result, driving of the liquid crystal panel 11 is controlled and the LEDs 17 in the backlight device 12 are turned on. Rays of light from the LEDs 17 are guided by the light guide plate 16 and passed through the optical member 15. As a result, the light from the LEDs 17 is converted to even planar light. The liquid crystal panel 11 is illuminated with the planar light and predetermined images are displayed on the liquid crystal panel 11. Functions of the backlight device 12 will be described in detail. After the LEDs 17 are turned on, rays of light emitted by the LEDs 17 enter the light entrance surface 16b of the light guide plate 16 as illustrated in FIG. 4. In a transmission process of the rays of light that enter the light entrance surface 16b and may be totally reflected off an interface between the light guide plate 16 and an air space outside the light guide plate 16 or reflected by the reflection sheet 20, the rays of light may be reflected by a reflection portion or scattered by a scattering portion. Then, the rays of light exit through the light exit surface 16 and the optical member 15 is irradiates with the rays of light. The reflection portion and the scattering portion are not illustrated.

After the liquid crystal display device 10 is turned on and the LEDs 17 are turned on, heat is produced by the LEDs 17. The heat produced by the LEDs 17 is transferred to the light source mounting portions 31 of the heat dissipation member 30 via the LED boards 18. The heat is transferred from the light source mounting portion 31 to the extending portions 32 and then from the rear surfaces 32b of the extending portions 32 to the chassis 14 (the holding portions 14b). The heat is dissipated to an air space behind the back surface of the chassis 14. Part of heat transferred to the extending portions 32 is transferred to the protrusions 33 and from the surfaces 33a on the light guide plate 16 side to the light guide plate 16 via the reflection sheet 20. The optical member 15 is disposed on the light exit surface 16a of the light guide plate 16 and thus the heat transferred to the light guide plate 16 is further transferred to the optical member 15.

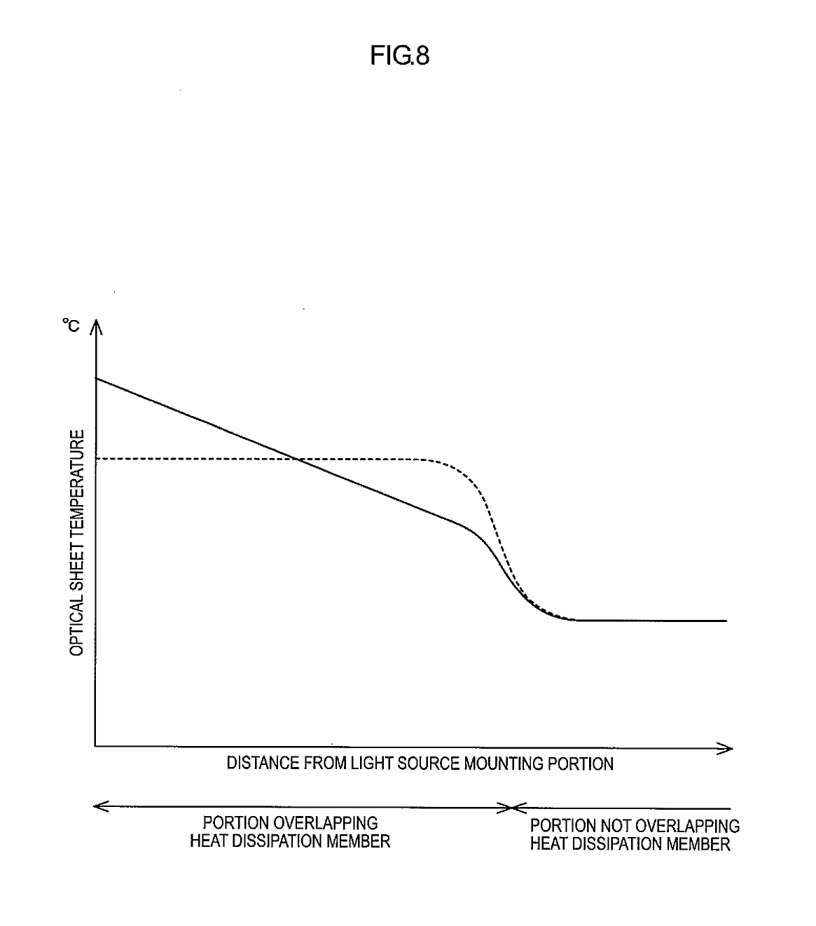

A solid line curve in FIG. 8 illustrates temperatures of the optical member 15 measured at points specific distances from the light source mounting portion 31. The X axis indicates a distance from the light source mounting portion 31 and the Y axis indicates a temperature of the optical member 15. As illustrated in FIG. 3 and as described earlier, heat is transferred to a portion of the optical member 15 which overlaps the extending portion 32 indicated below the X axis and a lower amount of heat is transferred from the heat dissipation member 30 to a portion of the optical member 15 which does not overlap the extending portion 32 than the portion that overlaps the extending portion 32. Therefore, a temperature gap occurs at the boundary between the portion that overlaps the extending portion 32 and the portion that does not overlap the extending portion 32.

A dotted line curve in FIG. 8 illustrates temperatures of an optical member (or an optical sheet) in a configuration in which a heat dissipation member that does not include protrusions measured at points specific distances from a light source mounting portion. In the configuration that does not include the protrusions, surfaces of plate-like shaped extending portions on the light guide plate side is in surface contact with a reflection sheet. Therefore, temperatures in a portion that overlaps the extending portion are substantially constant. In this embodiment, the area of the surfaces 32a of the projections 33 in contact with the reflection sheet 20 decrease as the distance from the light source mounting portion 31 increases. The temperature in the portion that overlaps the extending portion 32 decreases as the distance from the light source mounting portion 31 increases. In a condition that the amount of heat transferred from the heat dissipation member to the optical member in this embodiment (illustrated with the solid line curve) is equal to that in the configuration that does not include the protrusions (illustrated with the dashed line curve), the curves are compared. In this embodiment, the temperature of the optical member 15 is high in the area closer to the light source mounting portion 31 in comparison to the configuration that does not include the protrusions. The temperature is low at the boundary between the portion that overlaps the light source mounting portion 31 and the portion that does not overlap the light source mounting portion 31 in comparison to the configuration that does not include the protrusions. In comparison to the configuration in which the heat dissipation member does not include the protrusions, a temperature gap between the portion that overlaps the extending portion and the portion that does not overlap the extending portion is small.

The backlight device according to this embodiment includes the LEDs 17, the light guide plate 16, the optical member 15, and the heat dissipation members 30. The light guide plate 16 includes the light entrance surfaces 16b that are opposite the LEDs 17 and through which light from the LEDs 17 enters. The light guide plate 16 includes the light exit surface 16a through which the light exits. The optical member 15 is arranged on the light exit surface 16a side of the light guide plate 16. The heat dissipation members 30 are configured to dissipate the heat from the LEDs 17. Each heat dissipation member 30 includes the light source mounting portion 31, the extending portion 32, and the protrusions 33. The LEDs 17 are mounted to the light source mounting portion 31. The extending portion 32 is arranged on the opposite side of the light guide plate 16 from the light exit surface 16a. The extending portion 32 continues from the light source mounting portion 31 and extends from the light source mounting portion 31 along the opposite surface 16c of the light guide plate 16 from the light exit surface 16a. The protrusions 33 protrude from the surface 32a of the extending portions 32 on the light guide plate 16 side. The protrusions 33 are arranged parallel to each other in the extending direction of the extending portions 32. The area of the protrusions 33 per unit area decreases as the distance from the corresponding light source mounting portion 31 increases.

In the backlight device 12, the area of the protrusions 33 per unit area decreases as the distance from the corresponding light source mounting portion 31 increases. Therefore, the amount of heat transferred from the heat dissipation member 30 to the light guide plate 16 via the protrusions 33 decreases as the distance from the light source mounting portion 31 increases. In comparison to the configuration that does not include the protrusions, the temperature gap at the boundary between the portion that does not overlap the extending portion 32 and the portion that overlaps the extending portion 32 can be reduced. This configuration suppresses wrinkles or deformation of the optical member 15 due to thermal expansion of the portion that overlaps the extending portion 32.

In this embodiment, the dimensions of the protrusions 33 that measure in the extending portion (the Y-axis direction) decrease as the distance from the light source mounting portion 31 increases. This configuration is preferable for implementing the configuration in which the area of the protrusions 33 per unit area decreases as the distance from the light source mounting portion 31 increases.

In this embodiment, the interval between the protrusions 33 in the extending direction (the Y-axis direction) increases as the distance from the light source mounting portion 31 increases. This configuration is preferable for implementing the configuration in which the area of the protrusions 33 per unit area decreases as the distance from the light source mounting portion 31 increases.

In this embodiment, each protrusion 33 extends in the direction perpendicular to the extending direction of the extending portion (the X-axis direction) from one edge to the other. With this configuration, the heat is uniformly transferred from the heat dissipation members 30 to the light guide plate 16 in the direction perpendicular to the extending direction of the extending portions 32.

In this embodiment, each heat dissipation member 30 has the L-like cross section formed by the light source mounting portion 31 and the extending portion 32. The protrusions 33 are integrally formed with the extending portion 32. The protrusions 33 extend along the corner 30a defined by the light source mounting portion 31 and the extending portion 32. According to this configuration, the protrusions 33 are formed at the same time when the light source mounting portion 31 and the extending portion 32 are formed in the extrusion process of the heat dissipation member 30. Namely, the heat dissipation member 30 can be easily formed.

This embodiment further includes the chassis 14 arranged on the opposite side of the light guide plate 16 from the light exit surface 16a relative to the light guide plate 16 and the extending portions 32. The chassis 14 includes the bottom-plate portion 14a and the holding portions 14b. The surface 16c of the light guide plate 16 opposite from the light exit surface 16a is placed on the bottom-plate portion 14a. The holding portions 14b form steps together with the bottom-plate portion 14a and hold the respective extending portions 32 while being in surface contact with the surfaces 32b away from the light guide plate 16. With this configuration, the light guide plate 16 is stably supported by the bottom-plate portion 14a and the heat from the LEDs 17 is dissipated via the entire area of the chassis 14 by transferring the heat from the extending portions 32 to the holding portions 14b. Namely, this configuration has high heat dissipation capability.

This embodiment further includes the LED boards 18 on which the LEDs 17 are mounted. The LEDs 17 are mounted to the light source mounting portions via the LED boards 18. According to this configuration, the LEDs 17 are easily mounted to the heat dissipation members 30 and the heat from the LEDs 17 is efficiently transferred to the light source mounting portions 31.

The liquid crystal display device 10 according to this embodiment includes the backlight device 12 and the liquid crystal panel 11 configured to display images using the light from the light exit surface 16a of the light guide plate 16 included in the backlight device 12. According to the liquid crystal display device 10, because the backlight device 12 includes the optical member 15 configured to have less wrinkles and deformation, high display quality of the liquid crystal display device 10 is achieved.

This embodiment includes the liquid crystal panel 11 as a display panel. Such a display device, that is, the liquid crystal display device 10 can be applied to various devices including television devices and displays for personal computers. The liquid crystal display device 10 is especially suitable for large screen applications.

### First Modification of the First Embodiment

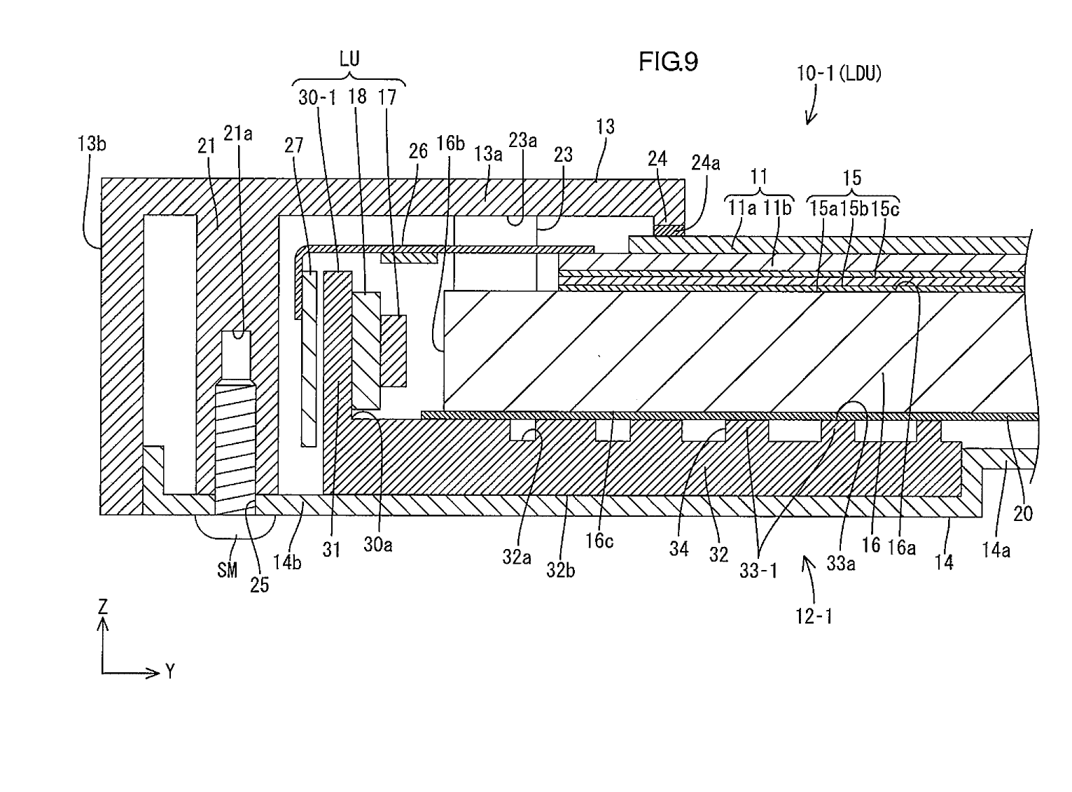

A first modification of the first embodiment will be described with reference to FIG. 9. This modification includes protrusions 33-1 arranged at different intervals from those of the protrusions 33.

A dimension of the protrusion 33-1 which measures in an extending direction of extending portions 32-1 (the Y-axis direction) decreases as a distance from the light source mounting portions 31 increases. The protrusions 33-1 are arranged at an equal interval. Therefore, a heat dissipation configuration of heat dissipation members 30-1 is easily designed through alteration of the dimensions of the protrusion 33-1 in the extending direction.

### Second Modification of the First Embodiment

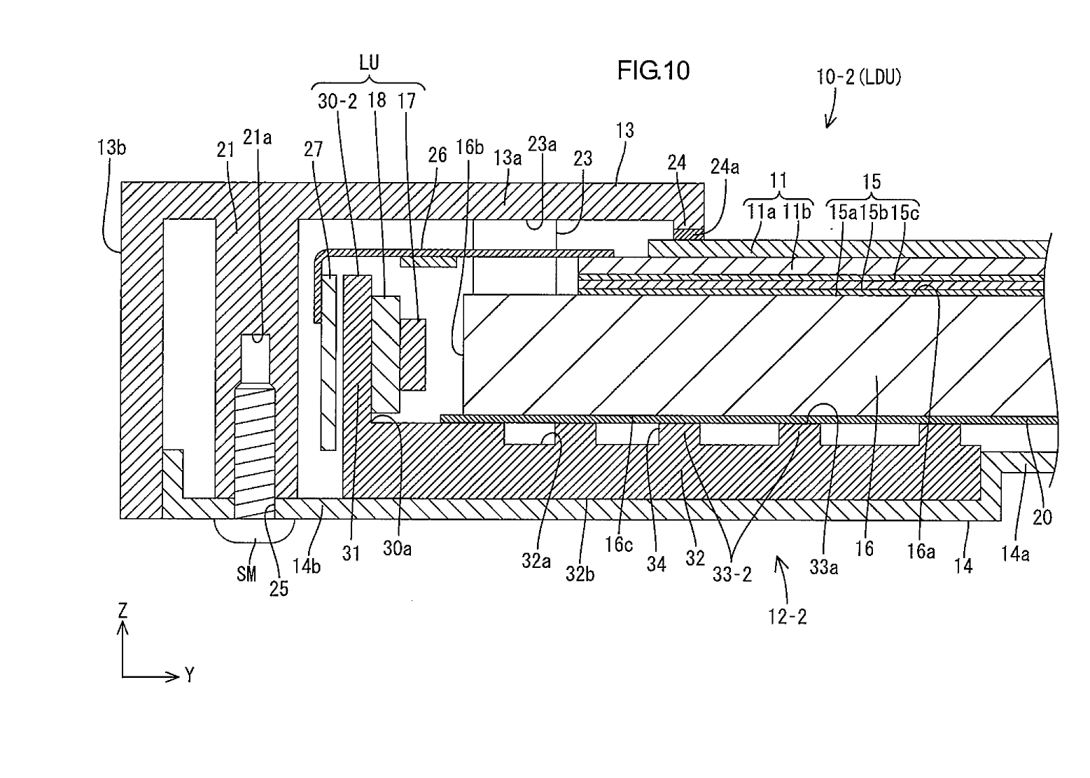

A second modification of the first embodiment will be described with reference to FIG. 10. This modification includes protrusions 33-2 having a different dimension that measures in the extending direction of the extending portions 32 from that of the protrusions 33.

The dimensions of the protrusions 33-2 in an extending direction of extending portions 32-2 (the Y-axis direction) are equal. The interval between the protrusions 33-2 in the extending direction increases as a distance from the light source mounting portions 31 increases. Therefore, a heat dissipation configuration of heat dissipation members 30-2 is easily designed through alteration of the interval between the protrusions 33-2 in the extending direction.

### Second Embodiment

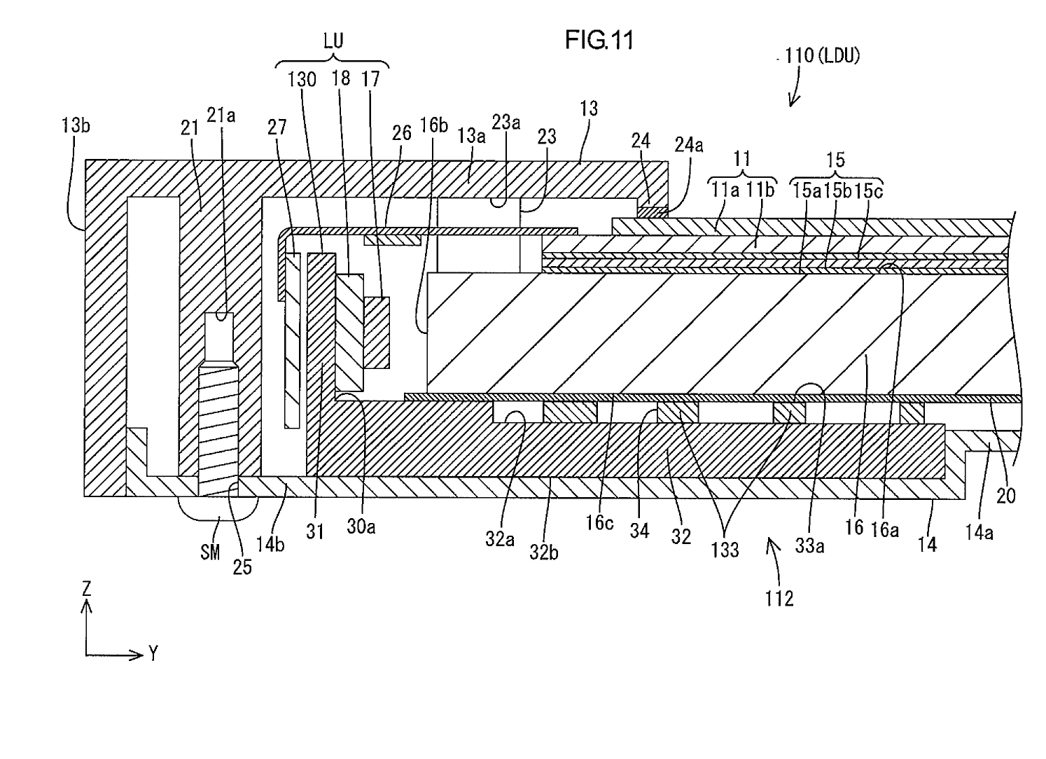

A second embodiment will be described with reference to FIG. 11. The second embodiment includes heat dissipation members 130 that include protrusions 133 having thermal conductivity lower than the extending portions 32. This configuration is different from the first embodiment. Other configurations are the same as the first embodiment. Similar configurations, operations, and effects to the first embodiment will not be described.

The protrusions 133 are made of synthetic resin such as expandable polycarbonate and PET, that is, the protrusions 133 have lower thermal conductivity than the extending portions that are made of metal. Each of the protrusions 133 is a rectangular column-like member. Each protrusion 133 is mounted to the extending portion 32 such that one of side surfaces thereof is in contact with the surface 32a of the extending portions 32 on the light guide plate 16 side. Examples of method of mounting the protrusions 133 to the extending portions 32 include mounting of the protrusions 133 to the extending portions 32 via adhesive layers and fitting of a projection formed on a surface of each protrusion 133 in a recess formed in the surface 32a of the corresponding extending portion 32 on the light guide plate 16 side.

The protrusions 133 of a backlight device 112 according to this embodiment are members having lower thermal conductivity than the extending portions 32. With this configuration, the amount of heat transferred from each heat dissipation member 130 to the light guide plate 16 via the protrusions 133 further decreases.

### Third Embodiment

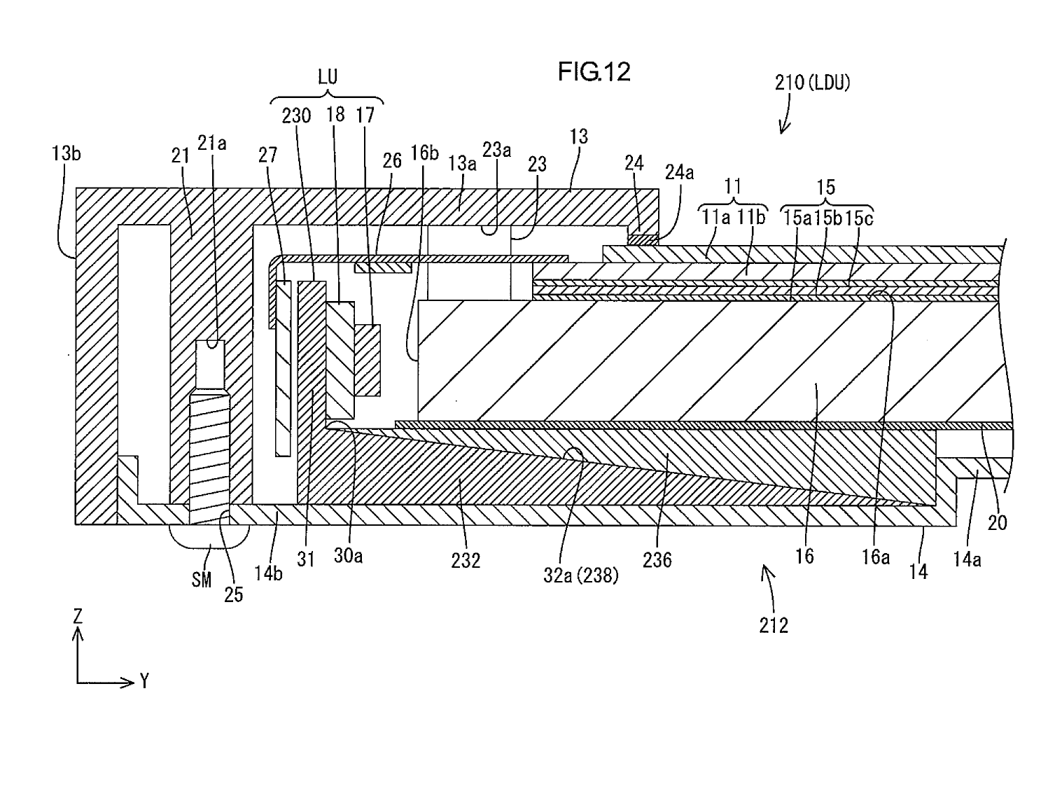

A third embodiment will be described with reference to FIG. 12. The third embodiment includes extending portions 232 having a different configuration from the first embodiment and heat dissipation members 230 include low thermally conductive portions 236, which is different from the first embodiment. Similar configurations, operations, and effects to the first embodiment will not be described.

Each heat dissipation member 230 in an LED unit LU includes a metal component having high thermal conductivity such as aluminum and a component having lower thermal conductivity than the metal component. The heat dissipation member 230 is configured to dissipate heat from the LEDs 17 to the backside. The heat dissipation member 230 includes a light source mounting portion 31, an extending portion 232, and a low thermally conductive portion 236. The LEDs 17 are mounted to the light source mounting portion 31. The extending portion 232 extends from the light source mounting portion 31 along an opposite surface of the light guide plate 16 from the light exit surface 16a. The low thermally conductive portion 236 having the thermal conductivity lower than the extending portion is disposed on the surface 32a of the extending portion 232 on the light guide plate 16 side.

Each extending portion has a plate-like shape parallel to the plate surfaces of the light guide plate 16 and the chassis 14. A long-side direction, a short-side direction, and a thickness direction of the extending portion 232 correspond to the X-axis direction, the Y-axis direction, and the Z-axis direction, respectively. The extending portion 232 is configured such that the thickness decreases as a distance from the light source mounting portion 31 increases. A surface 32a of the extending portion 232 on the front side, that is, opposite the light guide plate 16 (or the reflection sheet 20) is a sloped surface 238 that is sloped such that a distance from the opposite surface 16c of the light guide plate 16 from the light exit surface 16a increases as a distance from the light source mounting portion 31 increases.

Each low thermally conductive portion 236 is configured such that the thickness increases as a distance from the light source mounting portion 31 increases. The thickness of the low thermally conductive portion 236 increases as the thickness of the extending portion 232 decreases so as to complement the thickness of the extending portion 232. The extending portion 232 and the low thermally conductive portion 232 are attached to each other in a flat plate-like form. Examples of method of attaching the low thermally conductive portion 232 to the extending portion 232 include attaching of the low thermally conductive portion 232 to the extending portion 232 via adhesive layers and fitting of a projection formed on a surface of the low thermally conductive portion 232 on the extending portion 232 side in a recess formed in the surface 32a of the extending portion 232 on the light guide plate 16 side.

The backlight device 212 according to this embodiment includes the LEDs 17, the light guide plate 16, the optical member 15, and the heat dissipation members 230. The light guide plate 16 includes the light entrance surfaces 16b and the light exit surface 16a. The light entrance surfaces 16b are opposite the LEDs 17. Rays of light from the LEDs 17 enter through the light entrance surfaces 16b and exit through the light exit surface 16a. The optical member 15 is arranged on the light exit surface 16a of the light guide plate 16. The heat dissipation members 230 are configured to dissipate heat from the LEDs 17. Each heat dissipation member 230 includes the light source mounting portion 31, the extending portion 232, and the low thermally conductive portion 236. The LEDs 17 are mounted to the light source mounting portion 31. The extending portion 232 is arranged on the opposite side of the light guide plate 16 from the light exit surface 16a. The extending portion 232 continues from the light source mounting portion 31 and extends from the light source mounting portion 31 along the opposite surface 16c of the light guide plate 16 from the light exit surface 16a. The thickness of the extending portion 232 decreases as the distance from the light source mounting portion 31 increases. The low thermally conductive portion 236 is arranged on the surface 32a of the extending portion 232. The low thermally conductive portion 236 has lower thermal conductivity than the extending portion 232. The thickness of the low thermally conductive portion 236 increases as the distance from the light source mounting portion 31 increases.

In the backlight device 212, each extending portion 232 is configured such that the thickness thereof decreases as the distance from the light source mounting portion 31 increases. Furthermore, each low thermally conductive portion 236 is configured such that the thickness thereof increases as the distance from the light source mounting portion 31 increases. Therefore, the amount of heat transferred from the heat dissipation members 230 to the light guide plate 16 via the extending portions 232 and the low thermally conductive portions 236 decreases as the distances from the light source mounting portions 31 increase. In comparison to a configuration that does not include such portions as the extending portions 232 and the low thermally conductive portions 236, the temperature gap is small. This configuration suppresses wrinkles or deformation of the optical member 15 due to thermal expansion of the portion that overlaps the extending portion 232.

In this embodiment, the surface 32a of each extending portion 232 on the light guide plate 16 side is the sloped surface 238 hat is sloped such that a distance from the opposite surface 16c of the light guide plate 16 from the light exit surface 16a increases as a distance from the light source mounting portion 31 increases. According to this configuration, the amount of heat transferred from the light source mounting portions 31 to the light guide plate 16 via the extending portions 232 gradually decreases as the distance from the light source mounting portion 31 increases.

In this embodiment, each extending portion 232 and the corresponding low thermally conductive portion 232 are attached to each other in a flat plate-like form. Because the extending portion 232 and the low thermally conductive portion 232 are in the flat plate-like form, the extending portion 232 and the low thermally conductive portion 236 that are attached to each other can be arranged parallel to the light guide plate 16. Therefore, the heat dissipation members 230 and the light guide plate 16 are stably fixed together.

### Other Embodiments

The present invention is not limited to the embodiments described above and illustrated by the drawings. For examples, the following embodiments will be included in the technical scope of the present invention.

(1) In the first and the second embodiments, each protrusion has a rectangular column-like shape. However, the shape and the configuration of the protrusion may be modified as appropriate. For example, protrusions having a block-like shape may be arranged in a line along a direction perpendicular to the extending direction of the extending portion and lines of protrusions may be arranged in the extending direction of the extending portion so as to be parallel to each other. In this case, an area of the protrusions per unit area may be adjusted by altering the number of the protrusions in each line.

(2) The number, the shape, and the arrangement of the protrusions may be altered from those of the first embodiment, the second embodiment, or other embodiment (1) as appropriate.

(3) In the third embodiment, each extending portion includes the surface on the light guide plate side configured as a sloped surface. However, the configuration of the surface on the light guide plate can be altered as appropriate as long as the thickness of the extending portion decreases as the distance from the light source mounting portion increases.

(4) In the above embodiments, the heat dissipation members are arranged on the surface of the chassis on the light guide plate side. However, the heat dissipation members may be arranged on the surface of the chassis opposite from the light guide plate.

(5) The number, the kind, and the arrangement of the optical sheets may be altered from those of the above embodiments as appropriate.

(6) In the above embodiments, the liquid crystal display device including the liquid crystal panel as the display panel is used. However, the aspect of this invention can be applied to display devices including other types of display panels.

(7) In each of the above embodiments, two LED units (or two LED boards) are arranged opposite the respective long edges of the light guide plate. However, a configuration in which two LED units are arranged opposite the respective short edges of the light guide plate is included in the aspect of the present invention.

(8) Other than the above embodiment (7), a configuration in which four LED units (or four LED units) are arranged opposite the respective long edges and the respective short edges of the light guide plate is included in the aspect of the present invention. A configuration in which only one LED unit is arranged opposite the long edge or the short edge of the light guide plate is included in the scope of the present invention. Furthermore, a configuration in which three LED units are arranged opposite any of three edges of the light guide plate, respectively, is included in the aspect of the present invention.

(9) In the above embodiments, one LED unit (or one LED board) is arranged for one edge of the light guide plate. However, two or more LED units may be arranged for one edge of the light guide plate.

(10) In each of the above embodiments, the LEDs are used as light sources. However, other types of light sources including organic ELs may be used.

The embodiments have been described in detail. However, the above embodiments are only some examples and do not limit the scope of the claimed invention. The technical scope of the claimed invention includes various modifications of the above embodiments.

### EXPLANATION OF SYMBOLS

TV: television device, LDU: liquid crystal display unit, PWB: power source board, MB: main board, CTB: control board, CV: cover, ST: stand, LU: LED unit, 10, 110, 210: liquid crystal display device (display device), 11: liquid crystal panel (display panel), 12, 112, 212: backlight device (lighting device), 13: frame, 14: chassis, 14a: bottom-plate portion, 14b: holding portion, 15: optical member (optical sheet), 16: light guide plate, 16a: light exit surface, 16b: light entrance surface, 16c: surface, 17: LED (light source), 18: LED board (light source board), 30, 130, 230: heat dissipation member, 30a: corner, 31: light source mounting portion, 32, 232: extending portion, 32a: surface, 33, 133: protrusion, 34: recess, 236: low thermally conductive portion, 238: sloped surface

1. A lighting device comprising:
a light source;
a light guide plate arranged opposite the light source and including a light entrance surface through which light from the light source enters, and a light exit surface through which the light exits;
an optical sheet arranged on the light exit surface of the light guide plate; and
a heat dissipation member to dissipate heat from the light source, the heat dissipation member including:
a light source mounting portion to which the light source is mounted;
an extending portion arranged on an opposite side of the light guide plate from the light exit surface, the extending portion continuing from the light source mounting portion and extending from the light source mounting portion along an opposite surface of the light guide plate from the light exit surface; and
protrusions protruding from a surface of the extending portion on the light guide plate side, the protrusions being arranged in an extending direction of the extending portion so as to be parallel to each other and such that an area of the protrusions per unit area decreases as a distance from the light source mounting portion increases.

2. A lighting device comprising:
a light source;
a light guide plate arranged opposite the light source and including a light entrance surface through which light from the light source enters and a light exit surface through which the light exits;
an optical sheet arranged on the light exit surface of the light guide plate; and
a heat dissipation member to dissipate heat from the light source, the heat dissipation member including:
a light source mounting portion to which the light source is mounted;
an extending portion arranged on an opposite side of the light guide plate from the light exit surface, the extending portion continuing from the light source mounting portion and extending from the light source mounting portion along an opposite surface of the light guide plate from the light exit surface such that a thickness of the extending portion increases as a distance from the light source mounting portion increases; and
a low thermally conductive portion on a surface of the extending portion, the low thermally conductive portion having thermal conductivity lower than the extending portion and a thickness that decreases as a distance from the light source mounting portion increases.

3. The lighting device according to claim 1, wherein
each of the protrusions has a dimension that measures in the extending direction of the extending portion, and
the dimension decreases as the distance from the light source mounting portion increases.

4. The lighting device according to claim 1, wherein the protrusions are arranged such that an interval between the protrusions increases as the distance from the light source mounting portion increases.

5. The lighting device according to claim 1, wherein each of the protrusions extends from one end to another end in the direction perpendicular to the extending direction of the extending portion.

6. The lighting device according to claim 1, wherein
the heat dissipation member is formed such that the light source mounting portion and the extending portion form an L-like cross section, and
the protrusions are integrally formed with the extending portion and extend along a corner defined by the light source mounting portion and the extending portion.

7. The lighting device according to claim 1, wherein the protrusions are made of material having lower thermal conductivity than the extending portion.

8. The lighting device according to claim 2, wherein the extending portion includes a surface on a light guide plate side configured as a sloped surface that is sloped such that a distance from the opposite surface of the light guide plate from the light exit surface increases as a distance from the light source mounting portion increases.

9. The lighting device according to claim 2, wherein the extending portion and the low thermally conductive portion are attached to each other in a flat plate-like form.

10. The lighting device according to claim 1, further comprising a chassis arranged on an opposite side from the light exit surface of the light guide plate relative to the light guide plate and the extending portion, the chassis including:
a bottom plate portion on which an opposite surface of the light guide plate from the light exit surface is placed; and
a holding portion that forms a step together with the bottom plate and holds the extending portion while being in contact with a surface of the extending portion on a side opposite from the light guide plate.

11. The lighting device according to claim 1, further comprising a light source board on which a plurality of light sources each having a same configuration as that of the light source are mounted, wherein
the light sources are mounted to the light source mounting portion via the light source board.

12. A display device comprising:
a display panel displaying an image using light from the lighting device according to claim 1.

13. The display device according to claim 12, wherein the display panel is a liquid crystal panel including liquid crystals.

14. A television device comprising the display device according to claim 12.

15. The lighting device according to claim 2, further comprising a chassis arranged on an opposite side from the light exit surface of the light guide plate relative to the light guide plate and the extending portion, the chassis including:
a bottom plate portion on which an opposite surface of the light guide plate from the light exit surface is placed; and
a holding portion that forms a step together with the bottom plate and holds the extending portion while being in contact with a surface of the extending portion on a side opposite from the light guide plate.

16. The lighting device according to claim 2, further comprising a light source board on which a plurality of light sources each having a same configuration as that of the light source are mounted, wherein
the light sources are mounted to the light source mounting portion via the light source board.

17. A display device comprising:
a display panel displaying an image using light from the lighting device according to claim 2.

18. The display device according to claim 17, wherein the display panel is a liquid crystal panel including liquid crystals.

19. A television device comprising the display device according to claim 18.
